(19) United States
(12) Patent Application Publication
(10) Pub. No.: US 2014/0007376 A1
(43) Pub. Date: Jan. 9, 2014

(54) FLEXIBLE COMPOSITE HINGE

(71) Applicants: Paul R. Brewer, Bristol (GB); Steven Shorcott, Gloucestershire (GB); Reg R. Raval, North Somerset (GB)

(72) Inventors: Paul R. Brewer, Bristol (GB); Steven Shorcott, Gloucestershire (GB); Reg R. Raval, North Somerset (GB)

(21) Appl. No.: 13/667,426

(22) Filed: Nov. 2, 2012

(30) Foreign Application Priority Data
Jul. 6, 2012 (EP) 12250132.3

(51) Int. Cl. E05D 1/02

(52) U.S. Cl. 16/225

(57) ABSTRACT

A hinge for use with movable components is provided including a generally rectangular body. The body includes a bend region, a first flange, and a second flange. The first flange and the second flange are positioned on opposing sides of the bend region. A portion of the bend region has a reduced thickness relative to the first flange and the second flange. A hinge axis is defined within the bend region. The first flange and the second flange rotate about the hinge axis.

### CROSS REFERENCE TO RELATED APPLICATIONS

This application claims priority to European Patent Application No. 12250132.3 filed Jul. 6, 2012, the entire contents of which is incorporated herein by reference.

### BACKGROUND OF THE INVENTION

Exemplary embodiments of this invention generally relate to hinges and, more particularly, to a composite flexible hinge mechanism.

Hinges connect two objects and allow for angular rotation of the connected objects relative to one another. The connected objects may generally rotate freely about a fixed axis of rotation. Conventional hinges, such as the hinge 10 illustrated in FIG. 1 for example, are primarily fabricated from metals for use on rigid materials, such as doors, windows, furniture, and other products for example. Conventional hinges commonly include a single hinge pin 12 connecting two or more hinge plates 14. Each hinge plate 14 is fastened to a connected object for rotation about the axis X of the hinge pin 12.

Conventional hinges have many known drawbacks. Because conventional hinges include multiple moving parts, they are susceptible to wear over time. Frequent lubrication is often necessary to ensure consistent performance of the hinge. In addition, it is common for conventional hinges to become misaligned as a result of loading, extended use, and environmental conditions.

### BRIEF DESCRIPTION OF THE INVENTION

According to one embodiment of the invention, a hinge for use with movable components is provided including a generally rectangular body. The body includes a bend region, a first flange, and a second flange. The first flange and the second flange are positioned on opposing sides of the bend region. A portion of the bend region has a reduced thickness relative to the first flange and the second flange. A hinge axis is defined within the bend region. The first flange and the second flange rotate about the hinge axis.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a conventional hinge;

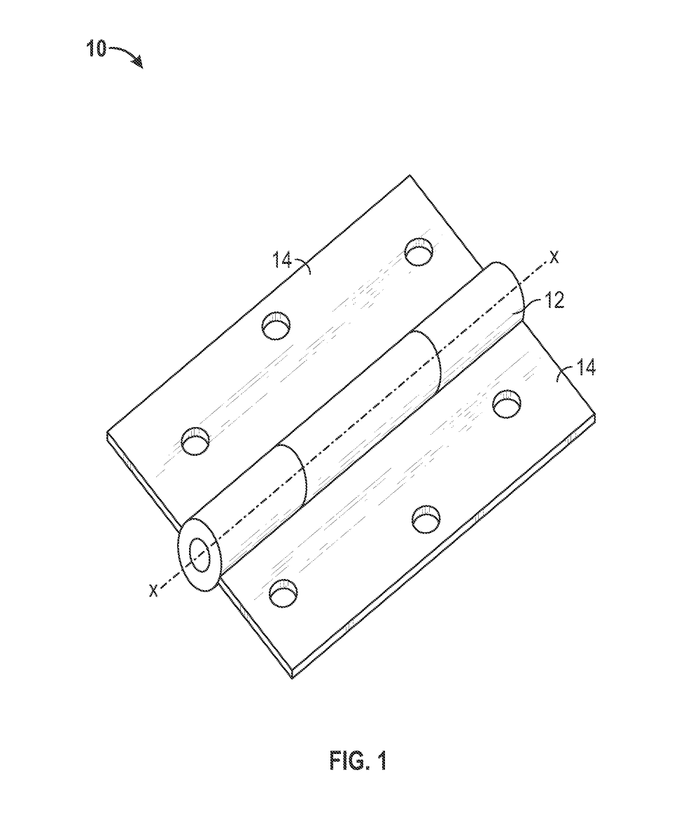

FIG. 2 is a cross-sectional view of an exemplary hinge according to an embodiment of the invention;

FIG. 3 is a cross-sectional view of an exemplary hinge when a force is applied according to an embodiment of the invention; and

FIGS. 4A-4C are a cross-sectional view of alternate hinge mechanisms according to the invention.

The detailed description explains embodiments of the invention, together with advantages and features, by way of example with reference to the drawings.

### DETAILED DESCRIPTION OF THE INVENTION

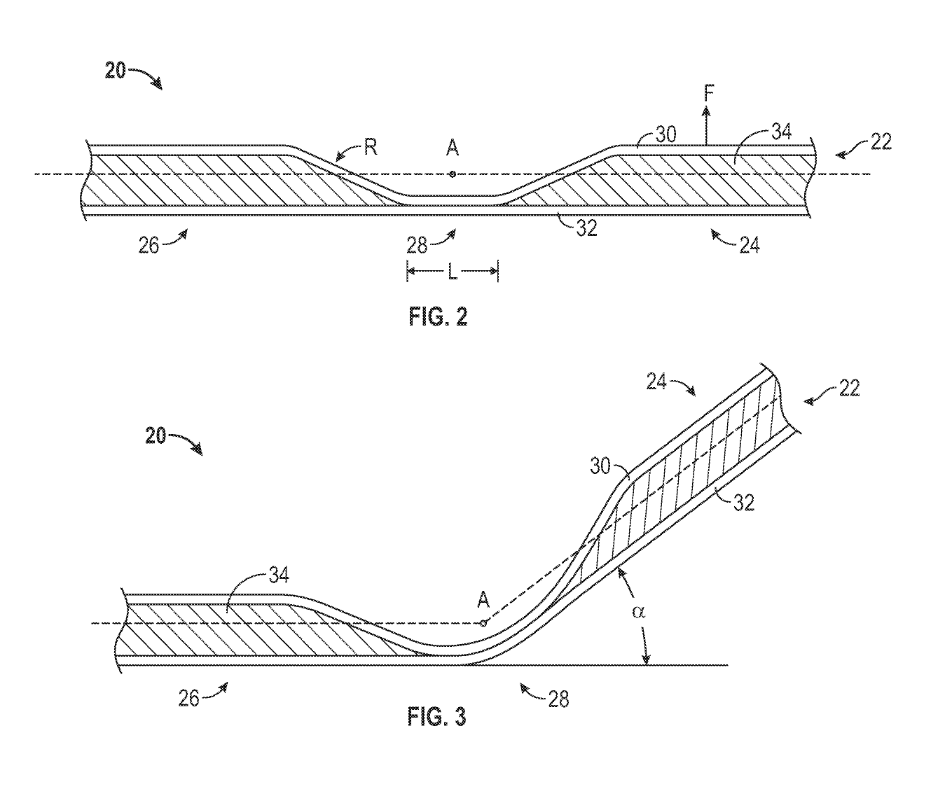

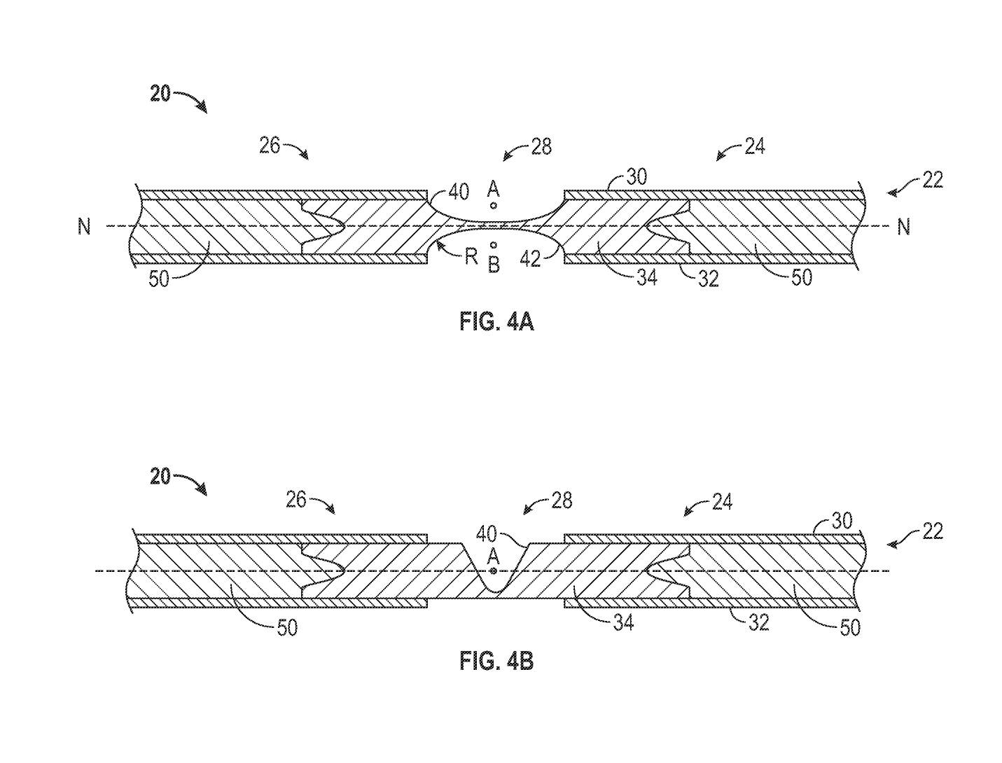

Referring now to FIGS. 2 and 3, a cross-section of an exemplary hinge 20 is illustrated. The hinge 20 has a generally rectangular body 22 including a first flange 24, a second flange 26, and a bend region 28 formed integrally with the first and second flanges 24, 26. The bend region 28 is positioned centrally between the first and second flanges 24, 26. At least a portion of the bend region 28 has a reduced thickness relative to the generally uniform thickness of the flanges 24, 26. In one embodiment, the thickness of the bend region 28 is smallest in the center of the bend region 28 than where it contacts the first and second flanges 24, 26. The thickness of the bend region 28 gradually increases from its center to a thickness generally equal to that of the first and second flanges 24, 26 at the interface between the bend region 28 and the flanges 24, 26. In one embodiment, the transition between the thickness of the bend region and the flanges 24, 26 has a radius R. Such a gradual increase in the thickness of the filler medium 34 between the bend region 28 and the flanges 24, 26 reduces the inter-laminar shear stress between adjacent fibers in the hinge 20. The bend region 28 defines a central hinge axis A, about which the flanges 24, 26 of the hinge 20 may flex.

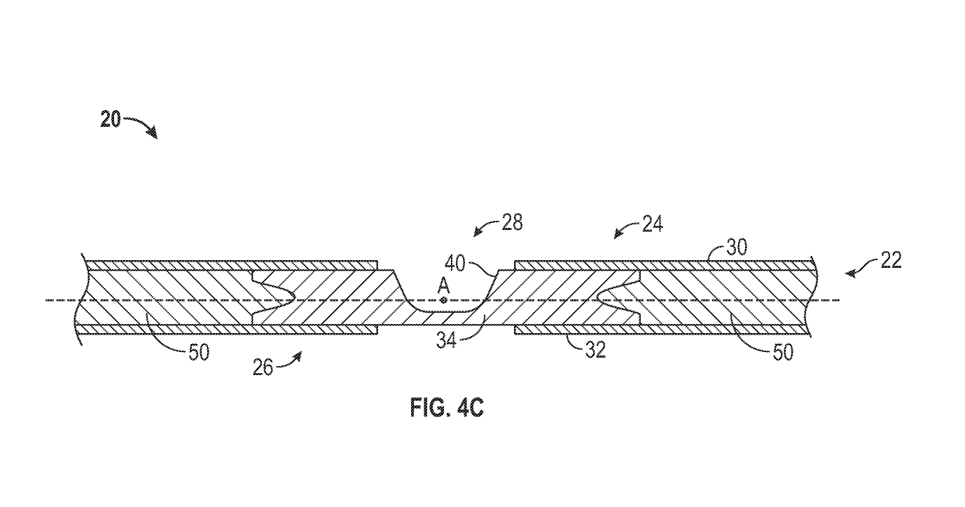

When the hinge 20 is in a rest position, the first flange 24 and the second flange 26 are aligned within a plane. As illustrated in FIG. 3, when a force F is applied to one of the flanges 24, 26, the hinge 20 flexes about the hinge axis A. The flange 24, upon which force F was applied, rotates an angle a from the planar rest position. Each flange 24, 26 of the hinge 20 may be connected to a movable component (not shown) such that the components rotate relative to one another about hinge axis A. In one embodiment, the flanges are connected to the movable components using an attachment means. Alternately, the flanges 24, 26 of the hinge 20 may be formed integrally with the movable components. In yet another embodiment, hinge plates 50 interface with the flanges 24, 26 to indirectly connect the hinge 20 to the movable components (see FIGS. 4A-4C).

The hinge body 22 is composed of a filler medium 34 having a minimal weight and a sufficient stiffness. Exemplary lightweight filler mediums 34 include paper, aluminum, foam and other materials known to a person skilled in the art. In one embodiment, the filler medium 34 has a honeycomb structure to reduce the weight of the hinge 20. The required thickness of the filler medium 34 is dependent on the intended loading and angle of operation of the hinge 20 and, therefore, will vary between hinge applications. An upper composite layer 30 and lower composite layer 32 are bonded to opposing edges of the filler medium 34, such as with a suitable adhesive, for example. Materials of the upper composite layer 30 and the lower composite layer 32 are selected based on the desired application of the hinge 20. Exemplary materials may include carbon fibers, glass fibers, and other materials known to a person skilled in the art.

Additives may also be included in the composite layers 30, 32 to enhance the operation of the hinge 20. For example, aramid fibers may be added to the composite layers 30, 32 when the hinge is intended for severe environments. The orientation of the fibers in the composite layers 30, 32 additionally affects the performance of the hinge 20. The upper and lower composite layers 30, 32 may include at least one layer of fibers positioned at 0 degrees, 45 degrees, and 90 degrees relative to the hinge axis A. In one embodiment, the upper and lower composite layers 30, 32 include a first layer of unidirectional composite fibers that are perpendicular to the hinge axis A. An additional layer of fibers having an alternate orientation may be added to the first layer. In one embodiment, these additional fibers are positioned at 0 degrees, or perpendicular to the fibers of the first layer, for reinforcement.

The bend region 28 of the hinge body 22 may be formed in various ways. Referring to the exemplary embodiment illustrated in FIG. 2, the upper composite layer 30 and the lower composite layer 32 are bonded together over a desired length L. With reference now to FIGS. 4A-4C, alternate hinge constructions are illustrated. In each of these drawings, the bend region 28 of the hinge 20 is created by forming one or more grooves in a portion of the generally rectangular filler medium 34. The upper and lower composite layers 30, 32 are then added to a portion of the hinge body 22 after the filler medium 34 has a desired shape.

The exemplary hinge 20 illustrated in FIG. 4A is symmetrical across a neutral axis N and allows for bidirectional operation. In one embodiment, the bend region 28 may be constructed by forming grooves 40, 42 in opposing sides of the filler medium 34 so that only a thin, central portion of the filler medium 34 remains. Grooves 40, 42 may be identical or alternately may be different sizes and shapes. Hinge axes A and B are defined centrally within the grooves 40, 42 respectively. The hinge 20 may flex about hinge axis A in a first direction and about hinge axis B in a second, opposite direction. Referring now to FIGS. 4B and 4C, the grooves 40 may be generally V-shaped. A groove 40 may be located on one side or both sides of the filler medium 34. The width of the groove 40 will vary with the application of the hinge 20. In embodiments where the bend region 28 is constructed by forming a groove in the filler medium, the upper and lower composite layers 30, 32 may not extend over a portion of the filler medium 34 in the bend region 28.

The hinge 20 does not include moving parts, and therefore, has an increased fatigue life and improved reliability and the potential for misalignment is reduced. Similarly, because the hinge 20 is a single piece, the functionality of the hinge 20 will not be affected by contamination, such as with sand, dirt, and debris for example. The hinge 20 additionally has an improved corrosion resistance and therefore will not require occasional lubrication to maintain consistent functionality. Because the hinge 20 is a composite structure, the size and weight of the hinge are reduced compared to conventional hinges.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention, which is defined by the claims. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A hinge for use with movable components comprising:
a generally rectangular body including a filler medium and an upper composite layer bonded to a first edge of the filler medium and a lower composite layer bonded to a second edge of the filler medium, the second edge being opposite the first edge, the body having an integrally formed bend region, and a first flange and a second flange positioned on opposing sides of the bend region, wherein a portion of the bend region has a reduced thickness relative to the first and second flange such that a hinge axis about which both the first flange and the second flange are configured to rotate is defined within the bend region and wherein the filler medium in the bend region gradually increases to a thickness generally equal to the first flange and the second flange at an interface between the bend region and the first flange and second flange.

2. The hinge according to claim 1, wherein the hinge is operable in a first direction.

3. (canceled)

4. The hinge according to claim 3, wherein the bend region is created by bonding a portion of the upper composite layer to a portion of the lower composite layer.

5. The hinge according to claim 3, wherein the bend region is created by forming a groove in a central portion of the filler medium.

6. The hinge according to claim 5, wherein groove in the filler medium is generally V-shaped.

7. The hinge according to claim 5, wherein the bend region is created by forming a first groove and a second groove in opposing sides of the central portion of the filler medium.

8. The hinge according to claim 7, wherein the hinge is symmetrical across a neutral axis.

9. The hinge according to claim 7, wherein the hinge is operable to flex along the hinge axis in a first direction and a second, directly opposite direction.

10. (canceled)

11. The hinge according to claim 10, wherein the interface between the bend region and the first flange and second flange includes a radius.

12. The hinge according to claim 3, wherein at least one of the upper composite layer and the lower composite layer includes a plurality of unidirectional fibers.

13. The hinge according to claim 12, wherein the plurality of unidirectional fibers are perpendicular to the hinge axis.

14. The hinge according to claim 12, wherein the plurality of unidirectional fibers is supported by additional fibers perpendicular to the unidirectional fibers.

15. The hinge according to claim 3, wherein the filler medium has a honeycomb structure.

16. The hinge according to claim 1, wherein the first flange is formed integrally with a first movable component and the second flange is formed integrally with a second movable component.

17. The hinge according to claim 1, wherein a first movable component is directly connected to the first flange and a second movable component is directly connected to the second flange.

18. The hinge according to claim 1, wherein a first hinge plate is connected to the first flange and a second hinge plate is connected to the second flange.
